(19) United States
(12) Patent Application Publication
(10) Pub. No.: US 2022/0311918 A1
(43) Pub. Date: Sep. 29, 2022

(54) IMAGING OPTICAL SYSTEM

(71) Applicant: Optotune Consumer AG, Dietikon (CH)

(72) Inventors: Stephan Smolka, Zürich (CH); Johannes Haase, Wädenswil (CH)

(73) Assignee: Optotune Consumer AG, Dietikon (CH)

(21) Appl. No.: 17/705,406

(22) Filed: Mar. 28, 2022

(30) Foreign Application Priority Data
Mar. 26, 2021 (IB) PCT/IB2021/052515

(51) Int. Cl. H04N 5/225; G02B 3/14; G02B 27/64

(52) U.S. Cl. CPC H04N 5/2254; G02B 3/14; G02B 27/646

(57) ABSTRACT

Imaging optical system comprising an objective with a compensation plate and an imaging sensor, wherein the objective is arranged to image objects which are arranged in an object plane in an image plane, a distance from the object plane to the objective is adjustable, the image sensor is arranged to capture the image in the image plane, a thickness of the compensation plate along the optical axis of the objective is adjustable, and the thickness depends on the distance.

### CROSS-REFERENCE TO RELATED APPLICATIONS

Benefit is claimed to International Patent Application No. PCT/IB2021/052515, filed on Mar. 26, 2021, the contents of which are incorporated by reference herein in their entirety.

### FIELD

The present disclosure relates to an imaging optical system. The imaging optical system may be part of a camera for capturing images, a microscope, a binocular, a telescope or a projector. The said images may be still images or moving images. The camera may be part of an electronic device, in particular a handheld device like a mobile phone.

### BACKGROUND

Imaging optical systems are optimized to reduce optical aberrations. However, some measures minimize aberrations of a first kind while having disadvantageous effects on other kinds of aberrations. In particular, miniaturized imaging optical systems require small radii of curvature of the lenses to achieve the desired focal length in a confined space. Due to small radii of curvature of the lenses these imaging optical systems suffer from field curvature. The present imaging optical system comprises a compensation plate which allows to compensate for field curvature, while having minimal impact on other aberrations.

### SUMMARY

According to one embodiment, the imaging optical system 1 comprises an objective with a compensation plate and an imaging sensor. The objective is arranged to gather electromagnetic radiation, in particular light, from an object being observed and focuses the light rays to produce a real image in an image plane. The objective may comprise a lens, a prism or a mirror, or combinations thereof. The objective may comprise a barrel shaped housing to which the lens, the prism and/or the mirror may be mounted.

The compensation plate is a transparent in particular clear (non-diffuse) optical component. The compensation plate is arranged in the optical path of the objective. The compensation plate may comprise a transparent material in the optical path of the objective, having a higher refractive index than material being arranged adjacent to the said transparent material upstream and/or downstream the optical path. The compensation plate comprises a first refractive surface and a second refractive surface, wherein electromagnetic radiation which is imaged onto the image sensor is refracted at the first and/or second refractive surface.

According to one embodiment, the objective is arranged to image objects which are arranged in an object plane O in an image plane I. A distance from the object plane O to the objective is adjustable. Here and in the following, the process of adjusting the distance is also referred to as focusing.

According to one embodiment, the image sensor is arranged to capture the image in the image plane. The image sensor may be a CMOS-Sensor or a CCD-Sensor, which is sensitive to electromagnetic radiation in the visible wavelength range. In case, the imaging optical system is incorporated in a projector for projecting images, a light source is arranged in the object plane and a screen is arranged in the image plane. Thus, for the purpose of projection, the image sensor is replaced by a screen.

According to one embodiment, a thickness of the compensation plate along an optical axis of the objective is adjustable. Here and in the following, the thickness of the compensation plate is measured along the optical axis of the objective, and the thickness is measured from the first refractive surface to the second refractive surface. In particular, in cases where the thickness varies over an optically active region of the compensation plate, the thickness corresponds to an average thickness over the optically active region. Said optically active region corresponds to the portion of the compensation plate, which is which is traversed by rays that are imaged on the image sensor.

According to one embodiment, the thickness depends on the distance. In particular, the thickness increases with decreasing distance and vice versa. For example, the thickness of the compensation plate is adjusted, such that the field curvature of the objective is reduced, preferably minimized.

The imaging optical system described herein is based on the following considerations, among others. In general, field curvature is an aberration in imaging systems which depends on the distance. However, objectives are optimized for a single distance.

The present imaging optical system now makes use of the understanding, that a beam shift by means of a compensation plate may reduce the field curvature. The beam shift depends on the angle of incidence of a beam and the thickness of compensation plate. Here and in the following, the beam shift describes the lateral shift of a beam—in a direction perpendicular to the optical axis of the objective—between the entry point on one side of the compensation plate and the exit point on an opposing side of the compensation plate. The dimensionless variable beam shift per plate thickness is non-linear with the angle of incidence. Advantageously, changing the thickness of the compensation plate depending on the distance between object plane and objective is a particularly efficient means for compensation of field curvature.

According to one embodiment the compensation plate comprises a first window element, a second window element and a liquid chamber between the first and the second window element. The first and second window elements are arranged on opposite sides of the compensation plate along the optical axis of the objective.

The liquid chamber is filled with a liquid L having a refractive index larger than air. In particular, the liquid L has a refractive index of at least 1.2 preferably 1.3, highly preferred 1.33. In particular, the liquid chamber is completely filled with the liquid L.

The first window element and the second window element are movable with respect to each other. In particular, the first window element and or the second window element is/are movable along the optical axis of the objective with respect to each other.

The thickness of the compensation plate is adjustable by altering the geometry of the liquid chamber. In particular, the geometry of the liquid chamber is altered by means of moving the first and/or second window element along the optical axis.

According to one embodiment, the objective comprises a lens, wherein the compensation plate is arranged between the lens and the image sensor along the optical axis of the objective. In particular, no further refractive optical elements, are arranged between the compensation plate and the image sensor.

According to one embodiment, the first window element comprises an optical filter which is arranged to absorb and/or reflect electromagnetic radiation in the wavelength range of infrared radiation. In particular, the first window element is arranged on a of the liquid chamber facing towards the image sensor.

According to one embodiment, the lens forms the second window element, and the imaging optical system is arranged to adjust the distance of the object plane to the objective and the thickness of the compensation plate by moving the lens with respect to the image sensor. For example, the lens forms the first or the second window element of the compensation plate. Alternatively, the lens is mechanically coupled to the first or he second window element, whereby the motion of the lens is at least partially transferred to the first or second window element.

According to one embodiment, a shape of the first refractive surface and/or a shape of the second refractive surface is static. The first window element and/or the second window element are at least one of: a flat transparent plate, a lens, or a prism. In particular, the compensation plate may have the same structure as the tunable prism disclosed in the US patent application publication US20200355910 A1, which is hereby included by reference.

According to one embodiment, the first window element is moveable with respect to the second window element in a direction perpendicular to the optical axis of the objective. In particular, the first window element and/or the second window element may be tilted, wherein the first and/or second window element is rotated around a rotational axis which is perpendicular with respect to the optical axis. For example, either the first window element or the second window element is movable in a direction perpendicular to the optical axis. Alternatively, the first and the second window element may perform a shearing motion with respect to each other.

According to one embodiment, the objective is arranged to perform optical image stabilization by movement of the first window element and/or the second window element in a direction perpendicular to the optical axis of the objective. The objective may be arranged to perform super resolution imaging by movement of the first window element and/or the second window element with respect to the optical axis of the objective. Here and in the following, super resolution imaging refers to a method for image acquisition, wherein multiple images are captured and merged together. For the individual images of said multiple images, the image is shifted by a portion of a pixel pitch of the image sensor. Thus, the resolution of the merged images is higher than the resolution of the individual images which were captured.

According to one embodiment, the lens comprises a tunable optical element, wherein the optical power of the tunable optical element is adjustable. The distance of the object plane O to the objective is adjusted (the image is focused) by adjusting the optical power of the tunable optical element. The optical power may be adjusted by altering the curvature of a refractive surface of the tunable optical element.

According to one embodiment, the tunable optical element comprises:

a lens volume which is filled with a lens liquid,

a lens membrane which delimits the lens volume on one side, and

a shaping element which is movable with respect to the lens volume.

The lens liquid is a transparent fluid which may have essentially the same properties as the liquid of comprised in the liquid chamber of the compensation plate. In particular, the lens liquid and the liquid L in the liquid chamber may be identical. In particular, the lens volume is completely filled with the lens liquid.

The lens membrane is an elastic membrane, which is adjacent to the lens liquid. In particular, the lens membrane forms a refractive surface of the tunable optical element, and the optical power of the tunable optical element is adjustable by changing a curvature of the refractive surface formed by the lens membrane by means of moving the shaping element with respect to the lens volume.

According to one embodiment, the imaging optical system comprises an actuator, which is arranged to generate an actuation force. The actuation force may be transferred to the compensation plate and to the tunable lens. The actuation force results in a movement of the shaping element with respect to the lens volume and in a movement of the first window element with respect to the second window element. The actuation force causes a change of the optical power and adjusts the thickness of the compensation plate.

According to one embodiment, the compensation plate comprises the tunable optical component. In particular, the liquid volume comprises the lens volume and the first window element comprises the lens membrane.

According to one embodiment, the objective is arranged to increase the thickness of the compensation plate when the optical power of the tunable optical component is increased and vice versa. The change in thickness of the compensation plate along the optical axis is larger than the change in thickness required to change the shape of the lens membrane for adjusting the optical power of the objective. In particular, the change in the thickness of the compensation plate is more than the change in the thickness caused by the increased or decreased curvature of the lens membrane.

In particular, the compensation plate may have the same structure as the tunable lens described in connection with the PCT publication WO2015/052233 A1, which is hereby included by reference.

According to one embodiment, the compensation plate comprises a wall which delimits the liquid chamber in directions perpendicular with respect to the optical axis circumferentially. The wall may comprise a bellows shaped structure, which may comprise a folded membrane material. In particular, the wall is formed by means of molded polymer. In particular, the wall is arranged to be deformed elastically. For example, the wall is arranged to provide the range of motion required for the adjustment of the thickness.

Alternatively, the wall comprises a rigid container, which does essentially not deform during a change of the thickness of the compensation plate. The wall may comprise a metal material, silicon, polymer or ceramic material. Container may have an opening extend through the container, whereby an optical aperture of the compensation plate is formed. At least one side of the opening may be covered by an elastic membrane which carried the first or second window element. The elastic membrane allows for motion of the first or second window element with respect to the container.

Further advantages and advantageous refinements and developments of the imaging optical system result from the following exemplary embodiments illustrated in connection with the figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1, 2, 3, 4, 5, 6, 7, 8, 9, 10, 16A, 16B and 16C show exemplary embodiments of an imaging optical system in a schematic sectional view;

FIGS. 11, 12, 13 and 14 show exemplary embodiment of compensation plates of imaging optical systems in a schematic top view;

FIGS. 15A, 15B and 15C show exemplary embodiments of an imaging optical system according to prior art;

FIGS. 17, 18 and 19 are graphs relating to beam shift with respect to thickness of a compensation plate and with respect to incident angle of a beam onto the compensation plate of exemplary embodiments of the compensation plate;

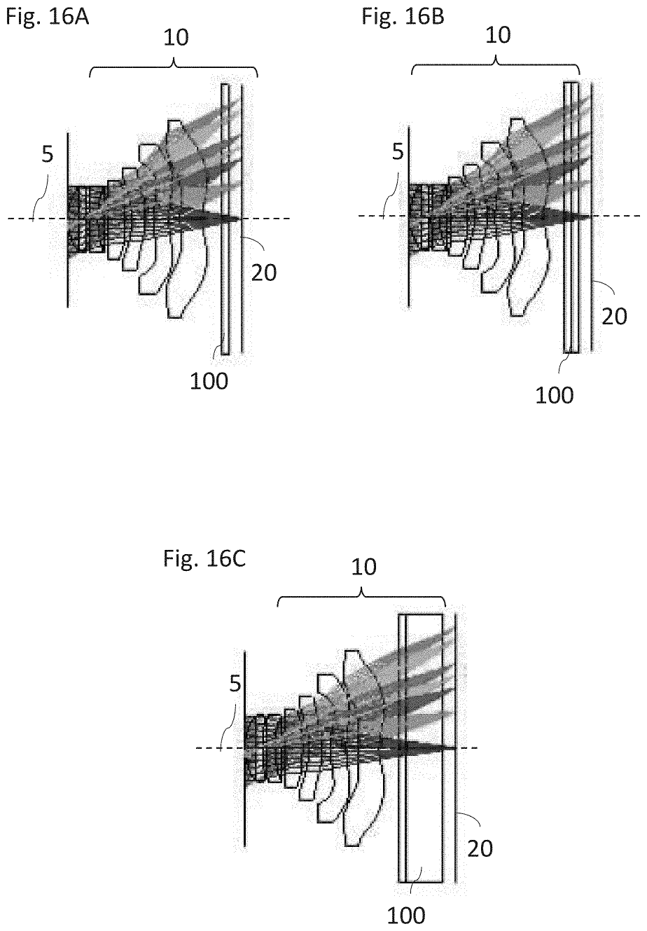

FIGS. 16A, 16B and 16C show exemplary embodiments of a first/second window element which is attached to a container at different temperatures according to prior art;

FIGS. 20A, 20B, and 20C show exemplary embodiments of a first/second window element which is attached to a container at different temperatures according to prior art;

FIGS. 21A, 21B, 21C and 22 show exemplary embodiments of a first/second window element which is attached to a container at different temperatures.

Identical or identically acting elements are provided with the same reference symbols in the figures. The figures and the proportions of the elements shown in the figures are not to be regarded as being to scale. Rather, individual elements can be shown exaggeratedly large for better representability and/or for better understanding.

### DETAILED DESCRIPTION

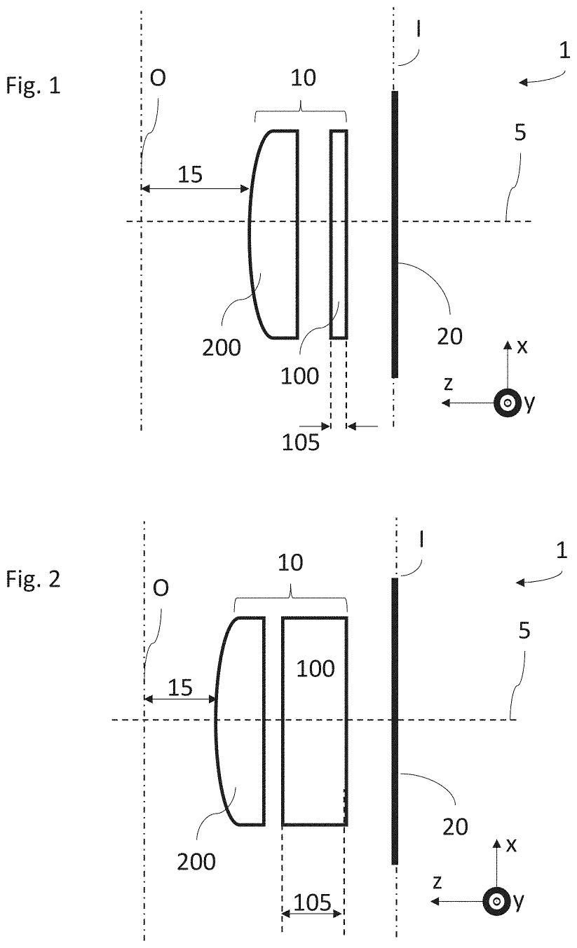

FIGS. 1 and 2 show an exemplary embodiment of an imaging optical system 1 in a schematic sectional view, comprising an objective 10 with a compensation plate 100 and an imaging sensor 20. The objective 10 is arranged to image objects which are arranged in an object plane O in an image plane I. A distance 15 from the object plane O to the objective 10 is adjustable and the image sensor 20 is arranged to capture the image in the image plane I. A thickness 105 of the compensation plate 100 along the optical axis 5 of the objective 10 is adjustable, and the thickness 105 depends on the distance 15. As shown in FIGS. 1 and 2, the distance in FIG. 2 is smaller than the distance 15 in FIG. 1, whereas the thickness 105 in FIG. 1 is smaller than the thickness 105 in FIG. 2.

The objective comprises a lens 200, wherein the compensation plate 100 is arranged between the lens 200 and the image sensor 100 along the optical axis 5 of the objective 10.

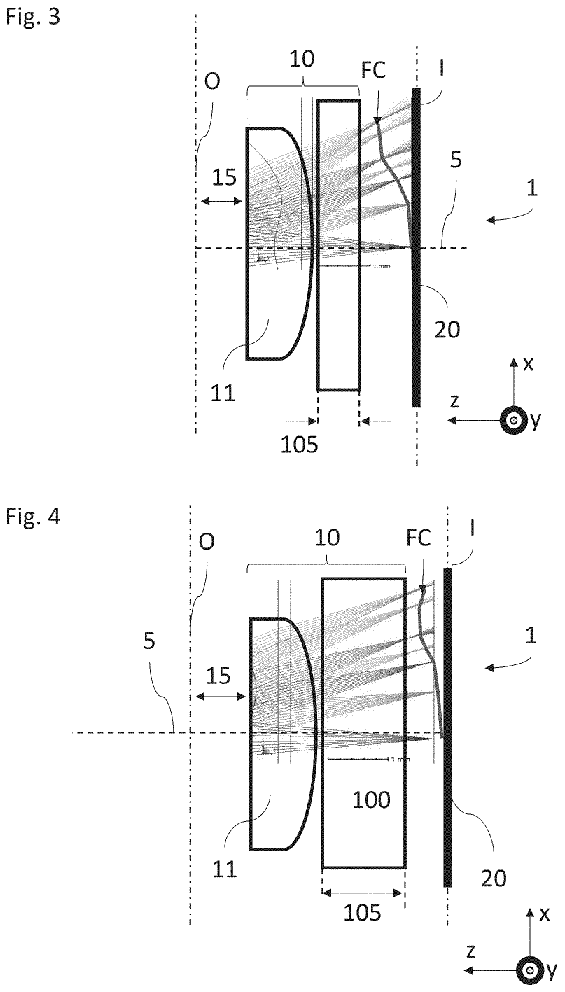

FIGS. 3 and 4 show an exemplary embodiment of an imaging optical system 1 with rays of light fields in a schematic sectional view. The rays of the light fields are under different incident angles, which results in different impact of the field curvature aberration on the different light fields. For illustration purposes, the line FC connects the focus points of the different fields. FIG. 3 shows an imaging optical system which is not optimized with respect to the field curvature. Thus, for fields having a larger incident angle, the distance of the focus to the image plane increases, which is typical for the field curvature. FIG. 4 shows an imaging optical system having identical distance 15 as the embodiment shown in FIG. 3, wherein the thickness 105 is larger in the embodiment of FIG. 4. The increased thickness shifts the focal points of light fields having larger incident angles more than light fields having smaller incident angles. Thus, the increased thickness 105 has a larger impact on the focal points of the peripheral light fields than on the focal points of the light fields close to the optical axis. Advantageously the increased thickness 105 reduces the field curvature, whereby the sharpness of the image is improved.

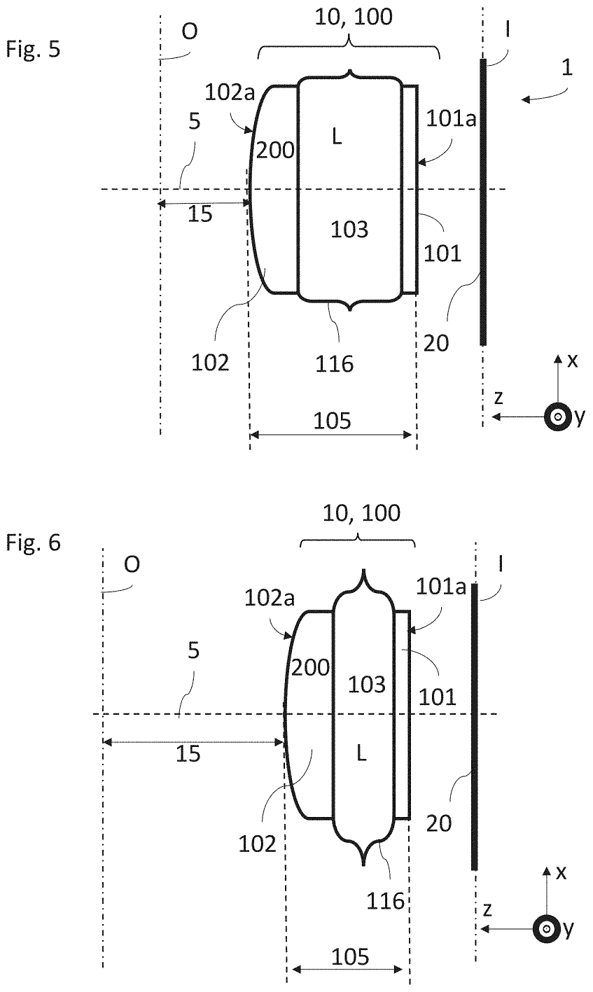

FIGS. 5 and 6 show an exemplary embodiment of an imaging optical system 1 in a schematic sectional view in two different focus modes having different distances 15 and different thicknesses 105. The compensation plate 100 comprises a first window element 101, a second window element 102 and a liquid chamber 103 between the first 101 and the second 102 window element. The liquid chamber 103 is filled with a liquid L having a refractive index larger than air. The first window element 101 and the second window element 102 are movable with respect to each other, and the thickness 105 of the compensation plate 100 is adjustable by altering the geometry of the liquid chamber 103.

The lens 200 forms the second window element 102. The imaging optical system 1 is arranged to adjust the distance of the object plane to the objective 10 and the thickness 105 of the compensation plate 100 by moving the lens 200 with respect to the image sensor 20.

The first window element 101 has a first refractive surface 101a and the second window element 102 has a second refractive surface 102a. A shape of the first refractive surface 101a and a shape of the second refractive surface 102a are static. The first window element 101 is a rigid lens and the second window element 102 is a flat transparent plate.

The compensation plate 100 comprises a wall 116 which limits the liquid chamber 113 in directions perpendicular with respect to the optical axis 5 circumferentially. The wall 116 is elastic and enables relative motion of the first and second window element. Moreover the wall 116 seals the liquid chamber 103 between the first and second window element in a fluid tight fashion.

An elastically deformable wall 116 circumvents the liquid chamber laterally (in X/Y-directions). The elastically

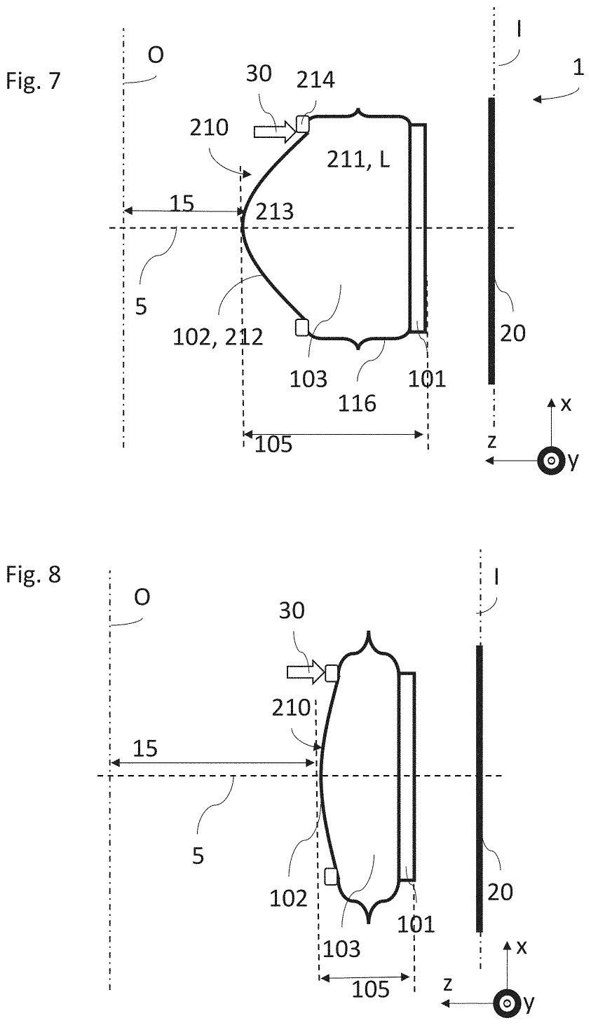

FIGS. 7 and 8 show an exemplary embodiment of an imaging optical system 1 in a schematic sectional view in two different focus modes having different distances 15 and different thicknesses 105.

The lens 200 comprises a tunable optical element 210, wherein the optical power of the tunable optical element 210 is adjustable, and the distance 15 of the object plane to the objective 10 is adjusted by adjusting the optical power of the tunable optical element 210.

The tunable optical element 210 comprises a lens volume 213 which is filled with a lens liquid 211, a lens membrane 212 which delimits the lens volume 213 on one side, and a shaping element 214 which is movable with respect to the lens volume 213.

The lens membrane 212 forms a refractive surface of the tunable optical element 210, and the optical power of the tunable optical element 210 is adjustable by changing a curvature of the lens membrane 112 by means of moving the shaping element 214 with respect to the lens volume 213.

The imaging optical system comprises an actuator 30, which is arranged to generate an actuation force. The actuation force results in a movement of the shaping element 214 with respect to the lens volume 213 and in a movement of the first window element 101 with respect to the second window element 102.

The compensation plate 100 comprises the tunable optical component 210. The liquid volume 103 comprises the lens volume 213 and the first window element 101 comprises the lens membrane 212. The objective 10 is arranged to increase the thickness of the compensation plate 100 when the optical power of the tunable optical component 210 is increased and vice versa. The change in thickness 105 of the compensation plate 100 along the optical axis 5 is larger than the change in thickness required to change the shape of the lens membrane 212 for adjusting the optical power of the objective 10.

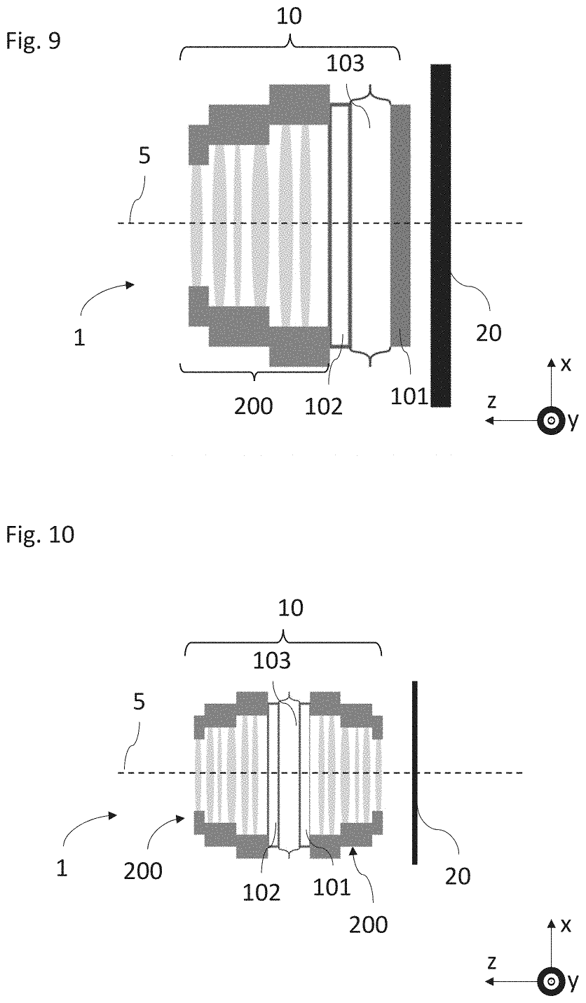

FIGS. 9 and 10 show exemplary embodiments of an imaging optical system 1 in a schematic sectional view. The objective 10 comprises a barrel with multiple static lenses, wherein the second window is fixedly attached to the barrel. For adjusting the focus, the barrel is moved along the optical axis 5, which results in displacement of the second window 102. The displacement of the second window 102 results in the adjustment of the thickness 105.

As shown in the embodiment of FIG. 9, the first window element 101 comprises an optical filter (IR-filter) which is arranged to absorb and/or reflect electromagnetic radiation in the wavelength range of infrared radiation. The IR-filter is arranged in close proximity to the imaging sensor. In particular, no further refractive optical elements are arrange along the optical path between the compensation plate 100 and the imaging sensor 20. Alternatively, as shown in FIG. 10, the IR filter is fixedly attached to the first window element 101.

As shown in the embodiment of FIG. 10, the lens 200 comprises two barrels. The compensation plate 100 is arranged between the two barrels 200. The compensation plate 100 may be arranged at any position within the objective. The compensation plate may be arranged on a side facing the image sensor 20, on a side facing the object plane O or between multiple optical components.

The second window element 102 is moveable in a direction perpendicular to the optical axis 5 of the objective 10. In particular, the lens 200 is arranged to be moved perpendicular with respect to the optical axis by shifting the lens 200 in the X/Y-plane or by rotating the lens 200 around the X-axis or the y-axis.

The objective 10 is arranged to perform optical image stabilization by movement of the first window element 101, in particular the lens with respect to the second window element 102 in a direction perpendicular to the optical axis 5 of the objective 10. Furthermore, the objective is arranged to perform super resolution imaging by movement of the second window element 102 with respect to the first window element 101 in a direction perpendicular to the optical axis of the objective 10.

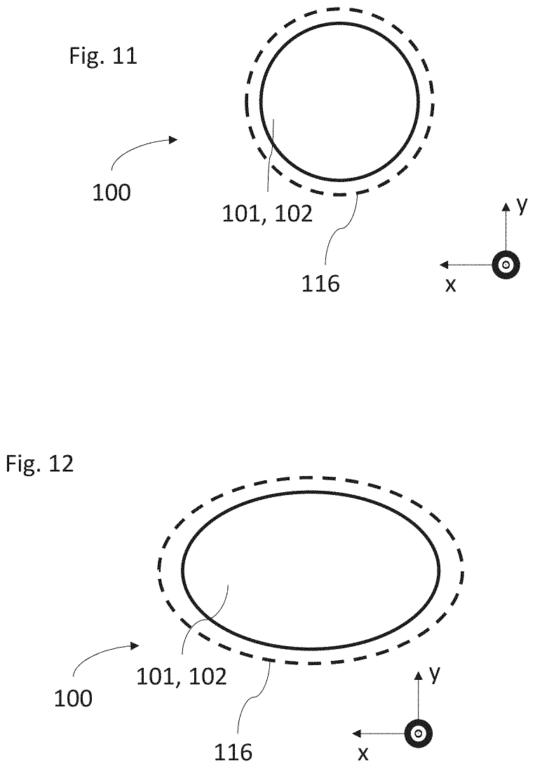

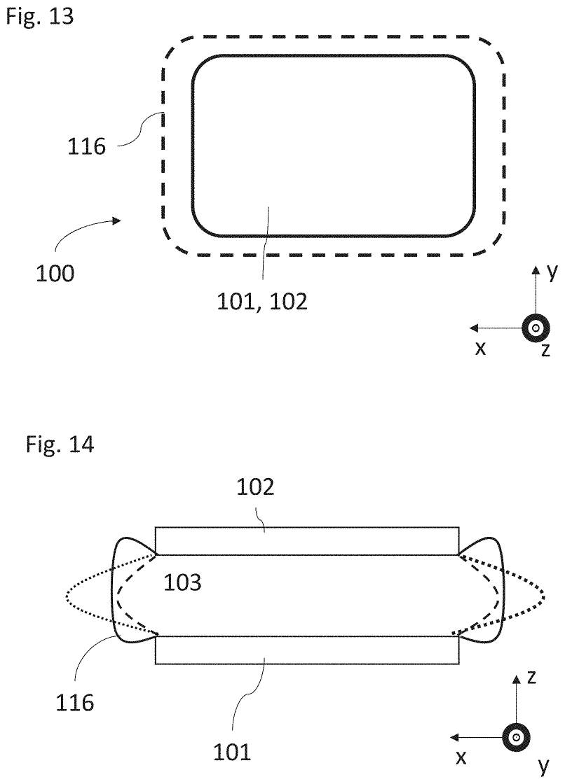

FIGS. 11, 12 and 13 show exemplary embodiments of compensation plates 100 of imaging optical systems in a schematic top view onto the first or second window element 101, 102. In a non, actuated state, the, the wall 116 protrudes over the outer edges of the first and/or second window element 101, 102. The compensation plate may have a circular (FIG. 11), elliptic (FIG. 12) or rectangular (FIG. 13) shape.

FIG. 14 shows an exemplary embodiment of a compensation plate 100 of an imaging optical system 1 in a schematic sectional view. The wall 116 is shown in three different configurations, which are indicated by a continuous line, a dotted line and a dashed line. In all these configurations the compensation plate is in a non-actuated state. The dashed line approximates the shape of the wall 116 in a non-actuated state without pre-tensioning. The continuous line approximated the shape of the wall 116 in a non-actuated state with pre-tensioning. The liquid L comprised in the part of the liquid volume 103 which protrudes over the outer edges of the first/second window element 101, 102 is increased by approximately 30%, in particular at least 10%, preferably at least 25%. The dotted line approximates the shape of the wall 116 in a non-actuated state without pre-tensioning, wherein the volume comprised in the portion of the liquid volume protruding over the first/second window element 101, 102 is 30% more than the volume in the protruding portion delimited by the wall depicted with the dashed line. Thus, to achieve the same total liquid volume, a non-pretensioned wall 116 requires more space along the X-Y-plane than a pretensioned wall 116. Advantageously, pre-tensioning the wall 116 allows for reduced lateral spatial requirements. The pre-tensioning may be achieved, by applying a force along the z-axis onto the compensation plate 100 in the non-actuated state. For the purpose of pre-tensioning the wall, the compensation plate is installed in the fully non-actuated state in such a way that pressure is exerted on the plate along the z-axis. Here and in the following, the z-axis corresponds to the optical axis 5.

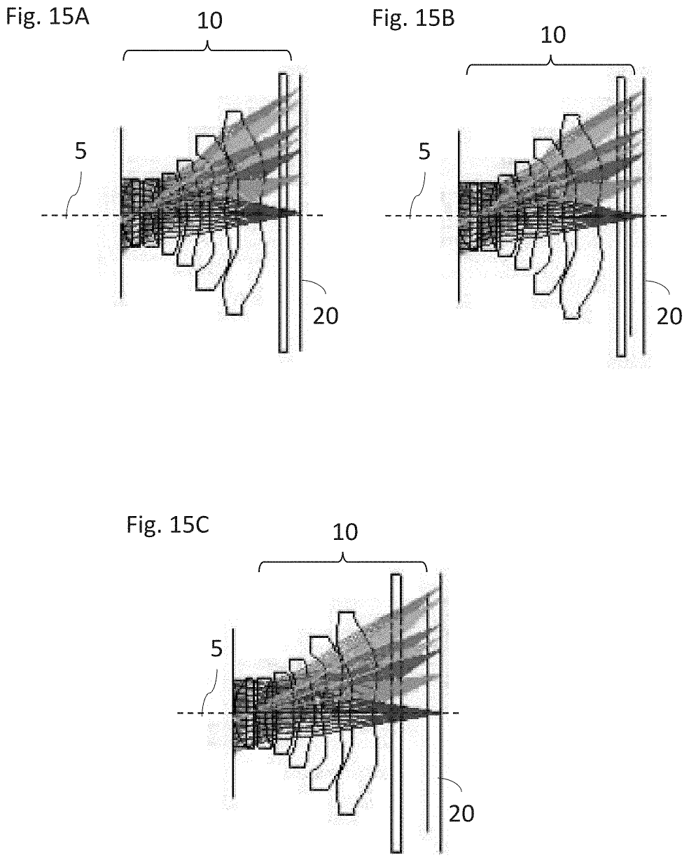

The FIGS. 15A, 15B and 15C show an exemplary embodiment of an imaging optical system 1 in a schematic sectional view according to prior art. The figures illustrate different focus states, wherein the distance 15 in FIG. 15A is infinity, in FIG. 15B the distance 15 is 100 mm and in FIG. 15c is 25 mm. The focus is adjusted, by shifting the objective 10 along the optical axis 5. For smaller distances 15 the field curvature increases.

The FIGS. 16A, 16B and 16C show an exemplary embodiment of an imaging optical system 1 in a schematic sectional view comprising a compensation plate 100. The figures illustrate different focus states, wherein the distance 15 in FIG. 16A is infinity, in FIG. 16B the distance 15 is 100 mm and in FIG. 16c is 25 mm. The focus is adjusted, by shifting the objective 10 along the optical axis 5. Additionally the thickness 105 of the compensation plate 100 is increased for decreasing distances. The increasing thickness 105 of the compensation plate counteracts the field curvature, which results in an improved image quality.

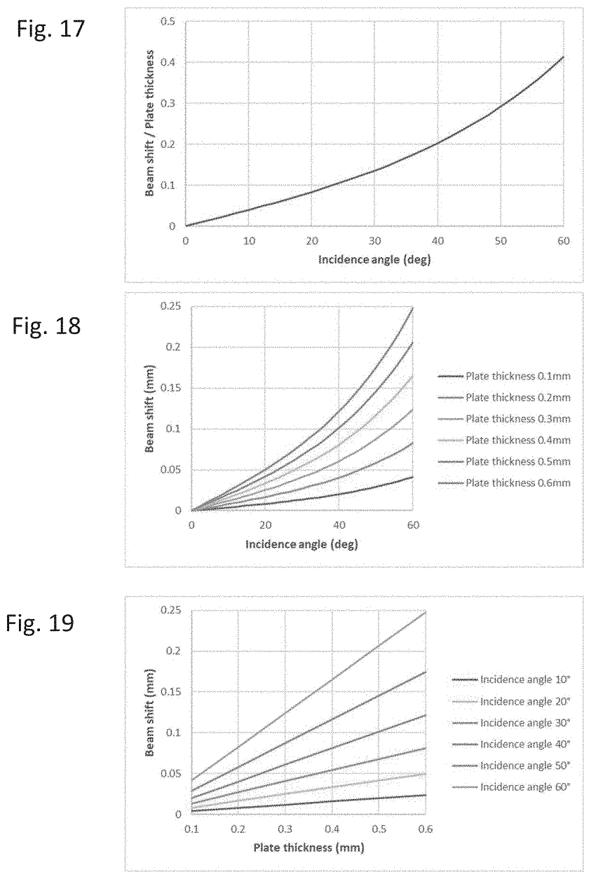

FIGS. 17, 18 and 19 show graphs which depict the relation of beam shift, thickness 105 (referred to as plate thickness) and incident angle of a beam incident onto the compensation plate 100. As apparent form FIG. 17, the dimensionless variable beam shift per plate thickness increases for increasing incident angles in a non-linear fashion.

As shown in the graph of FIG. 18, the beam shift increases with an increase of the incident angle. This effect is amplified for increasing plate thicknesses.

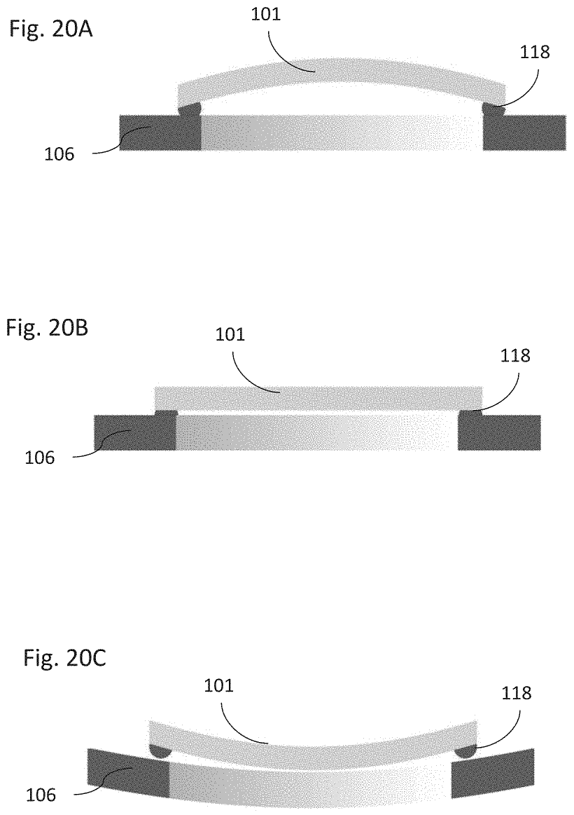

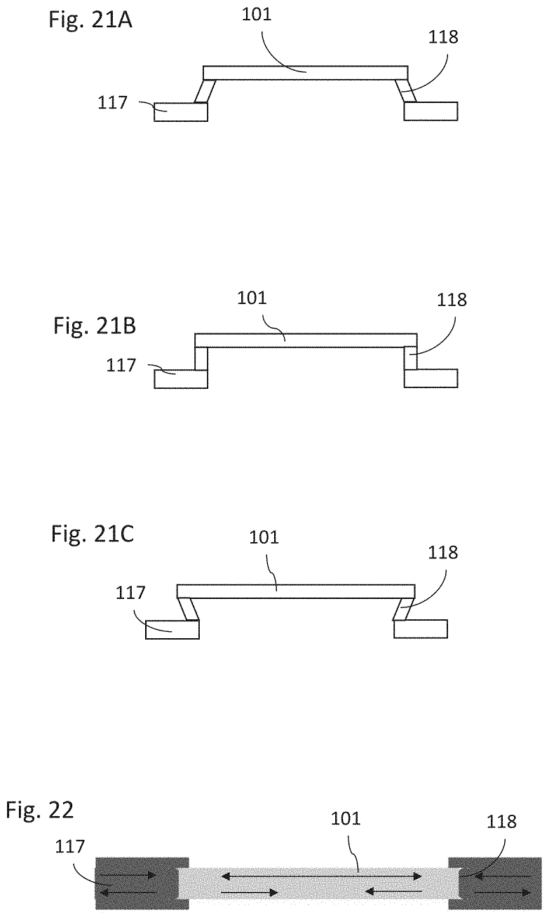

As shown in FIG. 19, the beam shift increases for increasing plate thickness in a linear fashion. This effect is amplified for increasing incident angles. Thus, increasing the plate thickness 105 is particularly well suited to compensate for field curvature, because the field curvature has a particularly strong impact onto beams having a large incident angle.

FIGS. 20A, 20B and 20C show an exemplary embodiment of a part of a compensation plate 100 comprised in the imaging optical system 1 in a schematic sectional view according to prior art. The first window element 101 is attached to a container 117. The container 117 and the first window element 101 differ in their thermal expansion. To fix the thickness tunable plate to the container, a barrel, an actuator, or a housing, the window element need to be glued to another material.

These materials are mostly plastic or metal and have a different thermal expansion coefficient (mostly higher than glass) than the coefficient of thermal expansion of the window element 101.

FIG. 20B depicts the first window element 101 and the container 117 at the temperature at which they were assembled. The window element 101 is attached to the container 117 by means of glue 118. When the temperature decreases, the container 117 contracts more than the first window element 101, which causes the window element to bend outwards, away from the container (FIG. 20A). When the temperature increases, the container 117 expands more than the first window element 101, which causes the window element to bend inwards, towards the container (FIG. 20C). The bending of the window element 101 introduces optical aberrations.

FIGS. 21A, 21B and 21C show an exemplary embodiment of a part of a compensation plate 100 comprised in the imaging optical system 1 in a schematic sectional view. To avoid the bending effect of the window element 101, depicted in FIGS. 20A-20C, the glue 118 is selected, such that the elastic modulus of the glue is sufficiently small, to compensate for the mismatch of the thermal expansion of the container 117 and the window element 101. In particular, the elastic modulus of the glue 118 is smaller than the elastic modulus of the window element 101 and the container 117. Additionally, the materials of the window element and the container 117 ma be selected such that the difference between the coefficients of thermal expansion of the materials is minimized. Furthermore an increased thickness of the window elements 101, 102 increases the resistance against bending of the window elements 101, 102.

FIG. 22 shows an exemplary embodiment of a part of a compensation plate 100 comprised in the imaging optical system 1 in a schematic sectional view. This, embodiment shows an arrangement of the window element 101 within an opening in the container 117. In this arrangement, the stress and the strain are in the same plane, which reduces the bending effects significantly.

The invention is not restricted to the exemplary embodiments by the description thereof. Rather, the invention encompasses any new feature and any combination of features, which in particular includes any combination of features in the patent claims, even if this feature or this combination itself is not explicitly specified in the patent claims or exemplary embodiments.

### LIST OF REFERENCE SIGNS

1 Imaging optical system
10 Objective
100 Compensation plate
101 First window element
102 Second window element
103 Liquid chamber
105 Thickness of liquid chamber
15 Distance of object plane to objective
200 Lens
210 Tunable lens
211 Lens liquid
212 Lens membrane
213 Lens volume
214 Shaping element
Optical axis
116 Wall
117 Container
118 Glue
FC Field curvature illustrating line
L Liquid
Object plane
I Image plane
Actuator
101a First refractive surface
102a Second refractive surface

We claim:

1. Imaging optical system comprising an objective with a compensation plate and an imaging sensor, wherein
the objective is arranged to image objects which are arranged in an object plane in an image plane,
a distance from the object plane to the objective is adjustable,
the image sensor is arranged to capture the image in the image plane,
a thickness of the compensation plate along the optical axis of the objective is adjustable, and
the thickness depends on the distance.

2. Imaging optical system according to claim 1, the compensation plate comprising a first window element, a second window element and a liquid chamber between the first and the second window element, wherein
the liquid chamber is filled with a liquid having a refractive index larger than air,
the first window element and the second window element are movable with respect to each other, and
the thickness of the compensation plate is adjustable by altering the geometry of the liquid chamber.

3. Imaging optical system according to claim 1, wherein the objective comprises a lens, wherein the compensation plate is arranged between the lens and the image sensor along the optical axis of the objective.

4. Imaging optical system according to claim 1, wherein the first window element comprises an optical filter which is arranged to absorb and/or reflect electromagnetic radiation in the wavelength range of infrared radiation.

5. Imaging optical system according to claim 1, wherein the lens forms the second window element, and the imaging optical system is arranged to adjust the distance of the object plane to the objective and the thickness of the compensation plate by moving the lens with respect to the image sensor.

6. Imaging optical system according to claim 1, wherein
the first window element forms a first refractive surface and the second window element forms a second refractive surface,
a shape of the first refractive surface and/or a shape of the second refractive surface is static, and
the first window element and/or the second window element are at least one of:
a flat transparent plate,
a rigid lens,
a rigid prism.

7. Imaging optical system according to claim 1, wherein the first window element and/or the second window element is moveable in a direction perpendicular to the optical axis of the objective.

8. Imaging optical system according to claim 7, wherein
the objective is arranged to perform optical image stabilization by movement of the first window element with respect to the second window element in a direction perpendicular to the optical axis of the objective and/or
the objective is arranged to perform super resolution imaging by movement of the first window element with respect to the second window element in a direction perpendicular to the optical axis of the objective.

9. Imaging optical system according to claim 1, the lens comprising a tunable optical element, wherein the optical power of the tunable optical element is adjustable, and the distance of the object plane to the objective is adjusted by adjusting the optical power of the tunable optical element.

10. Imaging optical system according to claim 9, wherein the tunable optical element comprises:
a lens volume which is filled with a lens liquid,
a lens membrane which delimits the lens volume on one side, and
a shaping element which is movable with respect to the lens volume, wherein
the lens membrane forms a refractive surface of the tunable optical element, and the optical power of the tunable optical element is adjustable by changing a curvature of the lens membrane by means of moving the shaping element with respect to the lens volume.

11. Imaging optical system according to claim 10, comprising an actuator, which is arranged to generate an actuation force, wherein the actuation force results in a movement of the shaping element with respect to the lens volume and in a movement of the first window element with respect to the second window element.

12. Imaging optical system according to claim 11, wherein
the compensation plate comprises the tunable optical component, wherein the liquid volume comprises the lens volume,
the first window element comprises the lens membrane.

13. Imaging optical system according to claim 12, wherein
the objective is arranged to increase the thickness of the compensation plate when the optical power of the tunable optical component is increased and vice versa, and
the change in thickness of the compensation plate along the optical axis is larger than the change in thickness required to change the shape of the lens membrane for adjusting the optical power of the objective.

14. Imaging optical system according to claim 1, the compensation plate comprising a wall which limits the liquid chamber in directions perpendicular with respect to the optical axis circumferentially.
